(19) United States
(12) Patent Application Publication
(10) Pub. No.: US 2006/0171618 A1
(43) Pub. Date: Aug. 3, 2006

(54) Lubrication oil retaining bearing assembly

(76) Inventor: Chin-Yen Shih, Pingtung Hsien (TW)

Correspondence Address: DELLETT & WALTERS, P. O. BOX 82788, PORTLAND, OR, 97282-0788, US

(21) Appl. No.: 11/047,973

(22) Filed: Jan. 31, 2005

(51) Int. Cl. F16C 19/00; F16C 33/02

(52) U.S. Cl. 384/276

(57) ABSTRACT

A lubrication oil retaining assembly includes a bearing sleeve having a passage, at least two bearings each having a head and a neck integrally formed with the head. The at least two bearings are interference fitted into the passage of the bearing sleeve in such a manner that an oil retaining space is defined between an inner periphery of the bearing sleeve and an outer periphery of each of the necks of the at least two bearings.

### BACKGROUND OF THE INVENTION

1. Field of the Invention

The present invention relates to a lubrication oil retaining bearing assembly, and more particularly to an oil retaining bearing assembly to provide lubrication to a motor axle rotatably received in the assembly so as to reduce noise incurred by engagement between the motor axle and the assembly.

2. Description of Related Art

Adequate provision of lubrication has long been a problem for bearing manufacturers in that the lubrication oil inside the bearing gradually dries out as time goes by. If there is no additional lubrication oil supplied to the bearing there will be discordant noise when the motor axle rotates inside the bearing and that noise is indicative of harmful friction. A further problem is that the available lubrication assembly is a combination of a bearing sleeve and a bearing interference fitted into the bearing sleeve via pressing. When the bearing is interference fitted into the bearing sleeve, the pressing force to the bearing may damage the bearing and cause high spots such that when the motor axle is rotating inside the bearing, noise is generated and the life span of a motor assembly is reduced.

To overcome the shortcomings, the present invention tends to provide an improved lubrication oil retaining assembly to mitigate the aforementioned problems.

### SUMMARY OF THE INVENTION

The primary objective of the present invention is to provide a lubrication oil retaining assembly having a bearing sleeve and at least two bearings securely received in the bearing sleeve and engaged with each other in such a manner that an oil retaining space is defined between an inner periphery of the bearing sleeve and each of the at least two bearings.

In one aspect of the present invention, each one of the at least two bearings has a head and a neck integrally formed with the head. Thus when the two necks are engaged with each other inside the axle sleeve, an oil retaining space is defined between an inner periphery of the bearing sleeve and each of the at least two bearings.

In another aspect of the present invention, each of the at least two bearings has an oil retaining groove defined in an inner periphery of the neck so as to provide lubrication oil to a motor axle rotatably received in the at least two bearings.

In yet another aspect of the present invention, a method of making the lubrication oil retaining assembly includes the steps of:

preparing a bearing sleeve;

preparing two bearings each having a head and a neck integrally formed with the head;

securing the two bearings into the bearing sleeve in such a manner that an oil retaining space is defined between an inner periphery of the bearing sleeve and an outer periphery of the neck of each of the two bearings;

immersing a combination of the bearing sleeve and the two bearings in a lubrication oil reservoir full of lubrication oil; and

vacuuming the combination of the bearing sleeve and the two bearings to allow the lubrication oil in the lubrication oil reservoir to flow into the oil retaining space.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the lubrication oil retaining assembly of the present invention;

FIG. 2 is a cross sectional view showing the assembly of the lubrication oil retaining assembly of the present invention;

FIG. 3 is a schematic side plan view in partial cross section showing the application of the lubrication oil retaining assembly in a motor assembly;

FIG. 4 is an exploded perspective view of a different embodiment of the lubrication oil retaining assembly; and

FIG. 5 is a cross sectional view showing the assembly of the lubrication oil retaining assembly in FIG. 4.

### DETAILED DESCRIPTION OF THE PREFERRED EMBODIMENT

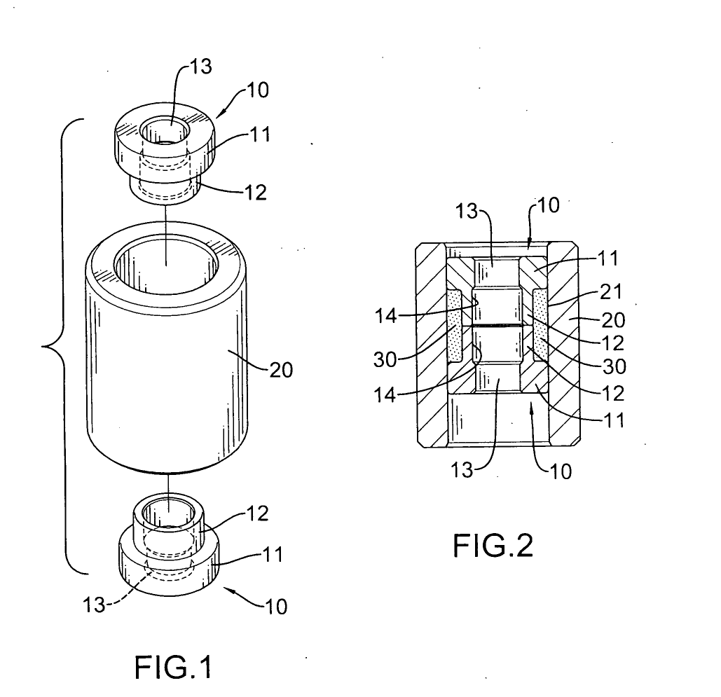

With reference to FIGS. 1 and 2, the lubrication oil retaining assembly of the present invention includes two bearings (10) and a bearing sleeve (20).

The bearing (10) includes a head (11) and a neck (12) integrally formed with the head (11), a through hole (13) centrally defined through the bearing (10) and an oil retaining groove (14) defined in an inner periphery defining the through hole (13) of the bearing (10). The bearing sleeve (20) has a centrally defined passage (21) defined to correspond to the two bearings (10).

When the two bearings (10) are combined with the bearing sleeve (20), the two bearings (10) are interference fitted into the passage (21) with the neck (12) of each bearing (10) facing the passage (21) until the peripheral end faces of the necks (12) engage with each other. It is noted that because the neck (12) has a diameter smaller than that of the head (11), after the two necks (12) engage with each other, an oil retaining space (30) is defined by an inner periphery of the bearing sleeve (20) and an outer periphery of each of the two necks (12) of the two bearings (10).

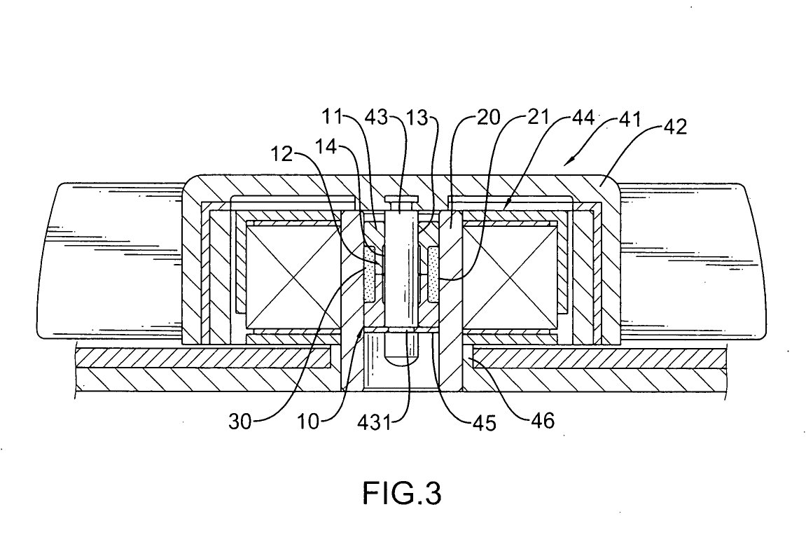

With reference to FIG. 3, the combination of the bearings (10) and the bearing sleeve (20) is able to be applied to a motor (41) having a rotor (42) provided with a motor axle (43) rotatably received in the motor (41) and a stator (44). The bearing sleeve (20) is able to be positioned at a positioning seat (46) inside the motor (41). The motor axle (43) is extended into the through holes (13) of the two bearings (10) and has an annular groove (431) defined in an end portion of the motor axle (43) to allow a retaining ring (45) to be received in the annular groove (431) to position the motor axle (43) inside the bearing sleeve (20). That is, a peripheral edge of the retaining ring (45) is securely engaged with the inner periphery of the bearing sleeve (20). After the combination of the bearings (10) and the bearing sleeve (20) is applied to the motor (41), the oil retaining space (30) is able to provide lubrication to the motor axle (43) via seeping into a gap between two peripheral end faces of the necks (12) of the two bearings (10). Further, because the gap communicates with the oil retaining grooves (14) of the two bearings (10), the lubrication oil from the oil retaining space (30) is able to constantly provide lubrication oil to lubricate the motor axle (43).

It is noted that after the combination of the two bearings (10) and the bearing sleeve (20), the combination is immersed in a lubrication oil tank. Then a vacuum process is applied to the oil retaining space (30) to allow the lubrication oil from the lubrication oil tank to flow into the oil retaining space (30) via the through holes (13) of the two bearings (10). Thus the oil retaining space (30) is full of lubrication oil. The lubrication oil is then confined in the oil retaining space (30) because the neck (12) has an outer diameter smaller than an inner diameter of the passage (21).

Still, it is noted that when the two bearings (10) are interference fitted into the bearing sleeve (20), only the outer periphery of the heads (11) of the two bearings (10) engage with the inner periphery of the bearing sleeve (20), deformation of the bearings (10) is reduced. As a result of minimal deformation, concentricity of the two bearings (10) is particularly good.

Furthermore, because of the oil retaining groove (14), the engagement between the motor axle (43) and the bearing (10) is focused on the inner periphery of the head (11), which is largely reduced when compared with a conventional bearing having no oil retaining groove defined in the inner periphery of the bearing. Thus the rotation of the motor axle (43) is smooth and quiet.

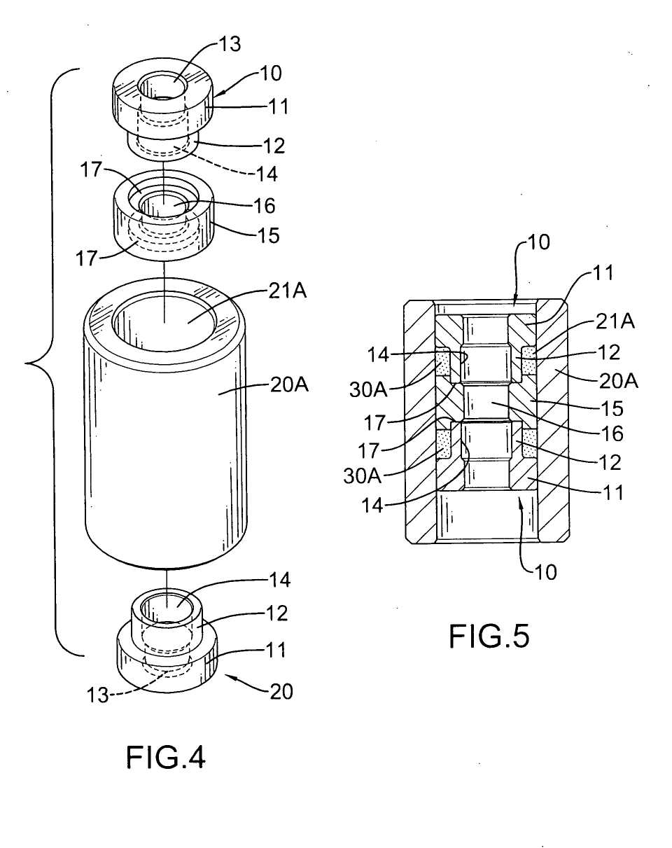

With reference to FIGS. 4 and 5, a different embodiment of the present invention is shown, wherein a connection bearing (15) is introduced between the two bearings (10). The connection bearing (15) has a central through hole (16) and two tapered openings (17) defined in opposite ends of the connection bearing (15) to communicate with the central through hole (16). The peripheral end face of each of the two necks (12) of the bearings (10) is securely abutted to a bottom face defining each of the tapered openings (17) and then the combination is inserted into the passage (21A) of a bearing sleeve (20A), wherein the passage (21A) has a depth larger than that of the passage (21) of the bearing sleeve (20) shown in FIGS. 1, 2 and 3. Therefore, with the introduction of the connection bearing (15), the lubrication oil retaining assembly of the present invention is able to be applied to bearing sleeves of different dimension.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for making a lubrication oil retaining assembly comprising the steps of:
preparing a bearing sleeve with a passage;
preparing at least two bearings to be interference fitted into the passage of the bearing sleeve, wherein each bearing has a head and a neck integrally formed with the head;
defining an oil retaining space between an inner periphery defining the passage and an outer periphery of the neck of each of the at least two bearings;
immersing a combination of the bearing sleeve and the at least two bearings in a lubrication oil reservoir full of lubrication oil; and
vacuuming the combination of the bearing sleeve and the two bearings to allow the lubrication oil in the lubrication oil reservoir to flow into the oil retaining space.

2. The method as claimed in claim 1 further comprising an introduction of a connection bearing between the at least two bearings.

3. The method as claimed in claim 2, wherein the connection bearing has a central through hole and two tapered openings communicating with the central through hole.

4. A lubrication oil retaining assembly made in according to the method as claimed in claim 3 comprising:
a bearing sleeve having a passage defined through the bearing sleeve;
at least two bearings each having a head and a neck integrally formed with the head, wherein the at least two bearings are interference fitted into the passage of the bearing sleeve in such a manner that an oil retaining space is defined between an inner periphery of the bearing sleeve and an outer periphery of each of the necks of the at least two bearings.

5. The assembly as claimed in claim 4, wherein each bearing has an oil retaining groove defined in the outer periphery of the bearing so that lubrication oil in the oil retaining space is able to seep through a gap between two peripheral end faces of the two necks and flow to the oil retaining groove for providing lubrication to a motor axle extending through the at least two bearings.

6. The assembly as claimed in claim 4 further comprising a connection bearing sandwiched between the at least two bearings.

7. The assembly as claimed in claim 5 further comprising a connection bearing sandwiched between the at least two bearings.

8. The assembly as claimed in claim 7, wherein the connection bearing has a central through hole and two tapered openings opposite to each other to respectively receive therein the peripheral end faces of the necks of the at least two bearings.

9. A lubrication oil retaining assembly comprising:
a bearing sleeve having a passage defined through the bearing sleeve;
at least two bearings each having a head and a neck integrally formed with the head, wherein the at least two bearings are interference fitted into the passage of the bearing sleeve in such a manner that an oil retaining space is defined between an inner periphery of the bearing sleeve and an outer periphery of each of the necks of the at least two bearings.

10. The assembly as claimed in claim 9, wherein each bearing has an oil retaining groove defined in the outer periphery of the bearing so that lubrication oil in the oil retaining space is able to seep through a gap between two peripheral end faces of the two necks and flow to the oil retaining groove for providing lubrication to a motor axle extending through the at least two bearings.

11. The assembly as claimed in claim 9 further comprising a connection bearing sandwiched between the at least two bearings.

12. The assembly as claimed in claim 10 further comprising a connection bearing sandwiched between the at least two bearings.

13. The assembly as claimed in claim 12, wherein the connection bearing has a central through hole and two tapered openings opposite to each other to respectively receive therein the peripheral end faces of the necks of the at least two bearings.
